(19) United States
(12) Patent Application Publication
(10) Pub. No.: US 2017/0147604 A1
(43) Pub. Date: May 25, 2017

(54) Database index for the optimization of distance related queries

(71) Applicant: Charles (Chip) Lynch, Louisville, KY (US)

(72) Inventor: Charles (Chip) Lynch, Louisville, KY (US)

(21) Appl. No.: 14/946,692

(22) Filed: Nov. 19, 2015

(51) Int. Cl. G06F 17/30

(52) U.S. Cl. CPC G06F 17/30241; G06F 17/30312; G06F 17/30424

(57) ABSTRACT

The invention is a method of storing multidimensional information in a database as an index to more efficiently process queries relating to the distance between members of database records. The index stores the distances of data points to fixed reference points such that mathematically complex distance functions can be reduced to basic subtraction and comparison.

The invention is a method of storing multidimensional information in a database as an index to more efficiently process queries relating to the distance between members of database records. The index stores the distances of data points to fixed reference points such that mathematically complex distance functions can be reduced to basic subtraction and comparison, improving query performance for certain types of queries. Among the types of queries improved are:
“Nearest-neighbor”¹ applications, where the database is queried to return points that are closest to each other in a multidimensional space. For example “what is the nearest restaurant” can see improved performance with this invention. ¹Nearest Neighbor: https://en.wikipedia.org/wiki/Nearest_neighbor
“Coverage” applications where the query asks what portion or how many records are within a certain distance of other points also see improvements from this treatment. For example “what percentage of our clients are within 10 miles of any post office”.

The dimensions need not be spatial in nature. Any distance function that quantifies a comparison of two pieces of data can be used. Distance functions exist to compare words, images, faces, and a wide variety of mathematical constructs.

This invention is most easily applied when the distance function in the space satisfies the triangle inequality² in multiple dimensions; that is, if the distance between points a and b is x, and the distance between a and c is y, then the distance between b and c is less than or equal to x+y, ensuring that comparing distances from mutual reference points are valid, however this is not strictly required. Driving distances, for example, may not follow this rule (due to one way streets), but the invention could still be used to improve performance of driving distance related queries. ²Triangle Inequality: https://en.wikipedia.org/wiki/Triangle_inequality

### TECHNICAL FIELD

The invention concerns the area of data management systems which store and retrieve information for review and analysis in response to queries. This invention is applicable to any system that stores data and processes queries or analysis based on a distance function. Distance functions can include spatial distances such as Euclidean geometric distances³, “Manhattan” driving distance⁴, and analytical constructs such as the Levenshtein distance' or Hamming distance⁶, for comparing text and images. ³Euclidean Distance: https://en.wikipedia.org/wiki/Euclidean_distance⁴Manhattan Distance: http://xlinux.nist.gov/dads//HTML/manhattanDistance.html⁵Levenshtein Distance: https://en.wikipedia.org/wiki/Levenshtein_distance⁶Hamming Distance: https://en.wikipedia.org/wiki/Hamming_distance

### BACKGROUND ART

Optimization of data processing is a common goal in computer science. A typical database system consists of methods of storing data on a computer and retrieving that information in response to queries. Relational Database Management Systems (RDBMS), which are the most common type, store descriptive information including names, relationships, and data types along with the actual data records, and indexes to improve performance. Many types of data can be stored in a database including numbers, words and text, images, sounds, and geo-spatial data including points, lines, and shapes.

These database systems process queries to retrieve and analyze the stored data. Some queries require complex calculations upon the data to return the results, for example when calculating the distance between two points on the globe, the haversine function⁷, which requires trigonometry, is often used. These complex functions are slow to execute, and methods to improve their processing speed are sought after. ⁷Haversine Function:https://en.wikipedia.org/wiki/Haversine_formula

Certain types of indexes such as “geo-spatial indexes” and physical storage constructs such as “B-Trees” and “Vantage Trees” are common strategies used to optimize these types of queries. They attempt to reduce the need to repeatedly perform these expensive calculations.

Some existing strategies focus on assigning the data points to buckets or areas such that the data within a given bucket are all near one another (with regards to the distance function)^{8,9}. Others focus on physically storing the data or index in a particular order that makes it efficient to answer certain types of distance related queries¹⁰. Many are combinations¹¹ of those techniques, or explicitly include other components such as temporal (date and time) information¹². ⁸https://www.google.com/patents/US6263334⁹https://www.google.com/patents/US20030187867¹⁰thttps://www.google.com/patents/US7689621¹¹https://www.google.com/patents/US7185023¹²https://www.google.com/patents/US7917458

### SUMMARY OF INVENTION

The present invention comprises a database index that stores a collection of distances calculated from each of a set of multidimensional data points {P₁,P₂, . . . , Pₙ} in the database to each of a number of reference points {R₁,R₂, . . . , Rₘ} particularly selected for this index, and a method of optimizing queries by leveraging this index to more quickly respond to distance related queries.

### TECHNICAL PROBLEM

Queries against databases concerning themselves with the distance between objects can be technically challenging and slow performing. For example:
1. “What post office is closest to each address in a city?” or “How many houses are within a 5 kilometer radius of each of a company's stores?”—examples of the “Nearest Neighbor” problem.
2. Covering distance queries occur in healthcare where regulations commonly require insurers to answer “what percent of their membership is within a set distance (i.e. 25 miles) of specialists of different types (hospitals, urgent care, dentists, etc.)”.
3. Facial recognition in images ask queries such as “which images of faces are most similar (closest) to a set of known faces?”

A database used to correct spelling errors would answer the question “which words are closest to this misspelled word?”

A plagiarism detection tool could search documents to determine which sections are nearly identical to other sections in other documents.

These are examples of common problems in the mathematics, many in a field called “Computational Geometry”. Each problem includes a data set and a comparison that can be described as a distance function in some number of dimensions.

Calculating these distances between any two pieces of data is often expensive, in terms of computer processing time. For example, the distance between two points on the earth, requires multiple trigonometric functions if it is treated as a perfect sphere. More accurate measurements, required for some precise engineering and aerospace applications which treat the earth more properly as an ellipsoid, are even more complicated and expensive.

Some image comparison algorithms return metric distances that are suitable for this type of analysis. For example a distance function based on the sum of the distances of a pixel-by-pixel comparison of two images could use Red, Green, Blue, and Alpha (transparency) channels (known as RGBA) as the basis of a 4-dimensional space (one dimension per channel). It is often not practical to perform these calculations millions or billions of times against large data sets, although naive solutions to the computational problems would require such processing (see Example 1).

### SOLUTION TO PROBLEM

In order to avoid having to repeatedly perform the complex distance calculations on the entire data set during every query, the solution in this invention comprises a database index that stores a collection of distances calculated from each of a set of multidimensional data points {P₁,P₂, . . . , Pₙ} in the database to each of a number of reference points. The steps performed to perform the invention are, broadly:
1. Identify the relevant distance function to the application and the underlying data. (See paragraph [0026])
2. Select a set of reference points, the number and specification of which depend on the distance function and data space. (See paragraph [0029])
3. Calculate the distances between each data point and the individual reference points and store the results of those calculations as an index in the database. (See paragraph [0032])
4. Use the indexed values to optimize subsequent queries by pruning the result set based on the indexed distances. (See paragraph [0038])

A distance function f(X,Y), where X and Y are points in the multidimensional space containing the database points, is required that produces a metric indicating the proximity or similarity of two data points as a number or numbers on a comparable scale. This invention does not require nor recommend any particular distance function, however certain properties of the distance functions must be considered, namely:
The distance function must return a metric, typically a real-valued number, that can be stored in a database.
The distance function must satisfy the condition that if f(X, R₁)−f(Y, R₁)=k then f(X, Y) is less than 2k+ε where ε is suitably small. “Suitably small” in this case is dependent on the application. This is a weak form of the triangle inequality in arbitrary dimensions where ε=0 degenerates to the standard form. The typical euclidean distance function is an example where ε=0. Driving distances within a city may have ε˜1 mile, since the shortest driving distance may may take different routes depending on one-way streets, the location of interstate ramps. (See FIG. 6).

The ideal number of reference points m, and the reference points themselves {R₁,R₂, . . . , Rₘ} are chosen within the same multidimensional space such that the smallest m where the vectors of distances from points Pᵢ and Pⱼ to each of the reference points—Vᵢ[1 . . . m]=[f(Pᵢ,R₁) f(Pᵢ,R₂), . . . , f(PᵢRₘ)] and Vⱼ[1 . . . m]=[f(Pⱼ,R₁), f(Pⱼ,R₂), . . . f(Pⱼ,Rₘ)]—are unique for any i and j.

This is typically possible with m significantly less than n. In standard multidimensional spaces, m can be equal to the number of dimensions plus 1. That is, on a 2-dimensional space, any point can be uniquely identified as the set of distances between three reference points that satisfy the requirement (in this case, the points are non-co-linear). This is commonly referred to as trilateration.13 ¹³Trilateration: https://en.wikipedia.org/wiki/Trilateration

In cases where the number of dimensions is large—possibly large enough to make either the index storage requirements or the performance of generating the initial index cumbersome—m can be made artificially smaller than the uniqueness condition requires. This will impact the effectiveness of the query optimization, due to the circumstances where Vᵢ and Vⱼ are identical for Pᵢ and Pⱼ that are not equal. The selection of m is a key tuning mechanism for the index, and this tuning ability is key to the efficacy of the invention.

The distance calculation f(X,Y) is calculated for each point in Pᵢ for all i against each reference point in Rⱼ to produce every vector Vᵢ as described in paragraph [0029]. The index entry for a point Pᵢ consists of that very vector of distances Vᵢ and the necessary database references to the point itself (Pᵢ).

The physical storage of the index can be done in several ways to optimize different types of queries.

One embodiment is to physically store the index as a classic inverted index sorted on the distance to the first reference point Vᵢ[1] (See examples and FIG. 7)

A similar embodiment is to store the reference distances as separate inversion entries so that the distance to each reference point from each data point is pre-sorted and searchable with a normal b-tree algorithm. (See FIG. 11)

Another embodiment is to store the index in sets of buckets based on banded distances to the first reference point Vᵢ[1], and sorted within those buckets based on the distance to the second reference point Vᵢ[2]. The number and size of buckets can be tuned to facilitate optimization in different situations. The physical manifestation of the bucket storage is most simply the order the index is stored on the disk, or a separate index attribute set to indicate different buckets. In particular, if the number of buckets is aligned with powers of two, then bitmap type index schemes14 can be used to efficiently identify the buckets and improve query ¹⁴Bitmap Index: https://en.wikipedia.org/wiki/Bitmap_index performance. (See FIG. 8, FIG. 9, and FIG. 10)

Note that the index entries in FIG. 10 could be in addition to or could replace the index entries in FIG. 7. Also, the bins resulting from the intersection of these buckets are of varying sizes and shapes, and the area covered by bins of equal distances from their reference point cover increasingly large areas. If the records being indexed are spread evenly over the map area, these conditions will cause them to be unevenly binned (more points will land in the outer rings than the inner rings for a given reference point). Tuning the number and placement of reference points, and a selective use of the bucket approach can reduce issues encountered by this scenario. This trend can be continued with large data sets where nested bucketing can continue to provide quicker navigation of the index in special cases.

The invention provides mechanisms for subsequent use of the indexed distances that can reduce the query response time for some computational geometry queries relying on the distance function. Several mechanisms can be used depending on the type of query.

A query looking for records of points Pᵢ within a distance d of a fixed point X would calculate Vₓ[1 . . . m]=[f(X,R₁), f(X,R₂), . . . , f(X,Rₘ)] and compare Vₓ[k] to Vᵢ[k] for kin {1 . . . n}. At any point, where |Vₓ[k]−Vᵢ[k]|>d is evidence that the point Pᵢ is farther from X than desired, so Pᵢ may be pruned from the results. Since the index is stored in a sorted manner for at least one of the values of k, and possibly bucketed for others, in standard cases this search and comparison can be performed very efficiently. For example, if d=10 and the index is sorted on the first reference distance, then any entry physically stored outside the range Vₓ[1]−10 and Vₓ[1]+10 can immediately be excluded without having to be explicitly read from storage (other than the few reads required to perform an efficient sorted index search to locate the minimum and maximum possible records). Basic pseudo code for this embodiment would be:

```
for k = 1 to m:
    set Vx[k] = f(X, R[k])
for i = 1 to n:
    set accept_flag = TRUE
    for j = 1 to m:
      if Vᵢ[j] not between Vₓ[j]-d and Vₓ[j]+d then set
      accept_flag = FALSE
    if accept_flag is TRUE then add Pᵢ to the result set A
return records in result set A
```

This can be significantly faster than naive queries, since the complex distance function only had to be calculated for the relatively small m times—between X and each reference point to create V′ₓ—rather than between X and each of the n data points, and because the core comparison between Vₓ and Vᵢ can make efficient use of the sorted and bucketed index by traditional methods such as binary search algorithms. For very expensive distance functions, it is even possible to perform the distance calculation fewer times by calculating Vx[1], pruning, then calculating Vx[2] only if needed (that is, if any records remain un-pruned or some other query criteria has not already been met). Basic pseudo-code for the query in this embodiment would looks like:

```
set Vx[1] = f(X,R[1])
search index for records i where Pᵢ[1] between Vₓ[1]-d and Vₓ[1]+d
  add matching index records to temporary result set A
if A is empty then return empty and exit
for k = 2 to m:
  set Vₓ[k] = f(X, R[k])
  search index over remaining records in A
      remove records from A where Vᵢ[k] not between Vₓ[k]-10
      and Vₓ[k]+10
  if A is empty then return empty set and exit
return the records remaining in A
```

Note that, if the index is sorted, then the first search is a traditional binary search. If the index is bucketed around the first reference point, then only the buckets that contain points within d units of Vₓ[1] need to be considered.

### ADVANTAGEOUS EFFECTS OF INVENTION

The invention allows the comparison of distances between records in a database without having to perform computationally expensive distance functions at query time.

The invention has other advantages that some existing geo-spatial and multidimensional indexes do not have. Namely:
The query optimizations can be executed in parallel if the index and database records are distributed in a parallel storage fashion.
The index can be associated with additional attributes irrelevant to the distance function or multidimensional space, in order to allow queries to utilize the index while specifying conditions beyond only the distance criteria, such as date or price information. Some currently available commercial geospatial indexes do not support such an association.
The index can be tuned, by changing the number of reference points m, and by storing the index in range buckets of tunable sizes, to facilitate efficient retrieval in a variety of circumstances.

### BRIEF DESCRIPTION OF DRAWINGS

FIG. 1 depicts a geographical region (in this example case the state of Kentucky) with three reference points selected as described in the invention per the example. The image includes example placements for a radio broadcast tower and some radio receivers representing possible data for indexing and analysis.

FIG. 2 graphically depicts how the invention selects receivers which are within 10 kilometers of the same distance from reference point 1 as the radio broadcast tower.

FIG. 3 graphically depicts how the invention selects receivers which are within 10 kilometers of the same distance from reference point 2 as the radio broadcast tower, having already applied the distance to reference point 1.

FIG. 4 graphically depicts how the invention selects receivers which are within 10 kilometers of the same distance from reference point 3 as the radio broadcast tower, having already applied the distance to reference points 1 and 2.

FIG. 5 comprises a closer view of the intersection of the distance calculation comparing all three reference points to within 10 kilometers of the center of circle A. It shows how some areas (region B) are optimized with only two reference points, and how some areas (region C) are not within the 10 kilometer circle, despite being compared to all three reference points.

FIG. 6 depicts a city block surrounded by four one-way streets, two addresses A and B, and a reference point R. A distance function based on the driving distance would have a short distance from A to R and R to B, which add up to the distance from A to B. However the distances are not reversible due to the one way streets, so the distance from R to A or B to R are much longer.

FIG. 7 denotes how an index based on a single reference point may store data sorted by the calculated distance to optimize queries based on the distance calculations. This is one standard approach to indexing—any approach applicable to numeric data, including partitioning, clustering, or hashing could be used—the requirement is only that the pre-computed distances themselves be stored so that they can be searched more efficiently than in the original record order. NOTE that the distances in this figure do not correspond to actual points on any other figure.

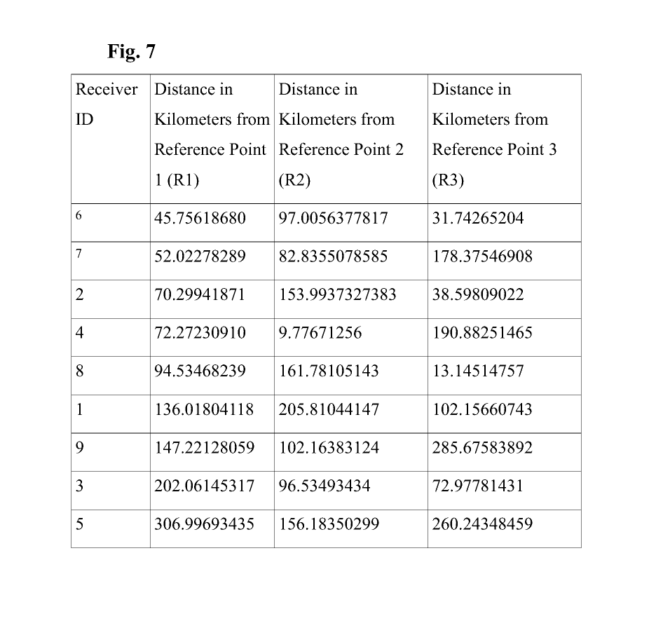

FIG. 8 depicts a possible collection of bins used to associate points on the map into groups based on their relative distance from point R1. In this example the bins are designed so that a bin can be described in 4 bits of computer storage.

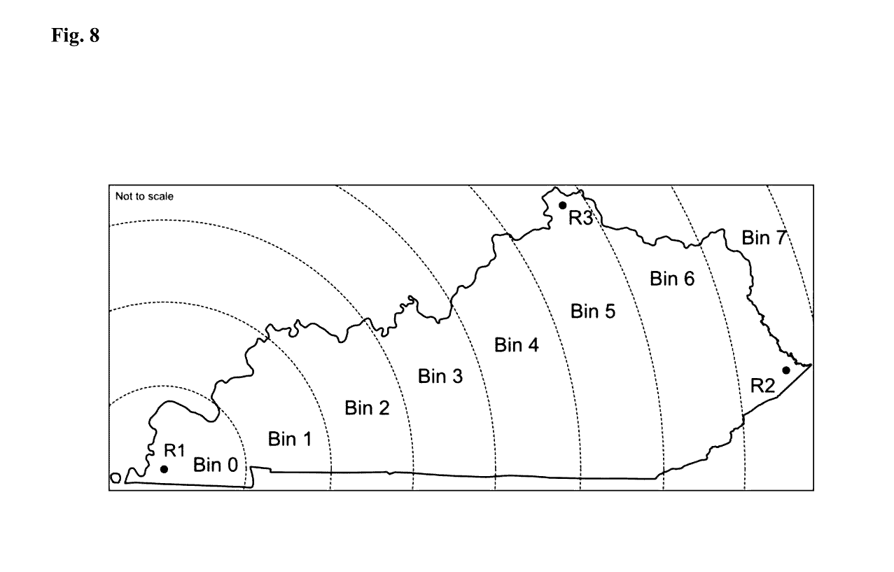

FIG. 9 depicts the set of all buckets from each reference point overlaid onto the example map. Any point on the map (such as a tower or receiver from example 1) falls into one bin from each of the three example reference points.

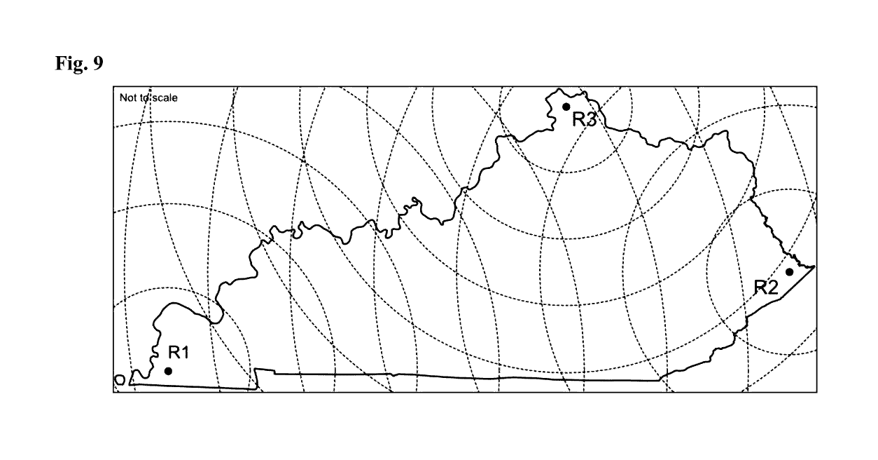

FIG. 10 provides an example of the bin assignments based on a 20-kilometer bucket distance. These are the same records as in FIG. 7, but note that the sort order is different for records 2 and 4 which fall into the same bin with respect to reference point R1, but into different bins for reference point R2.

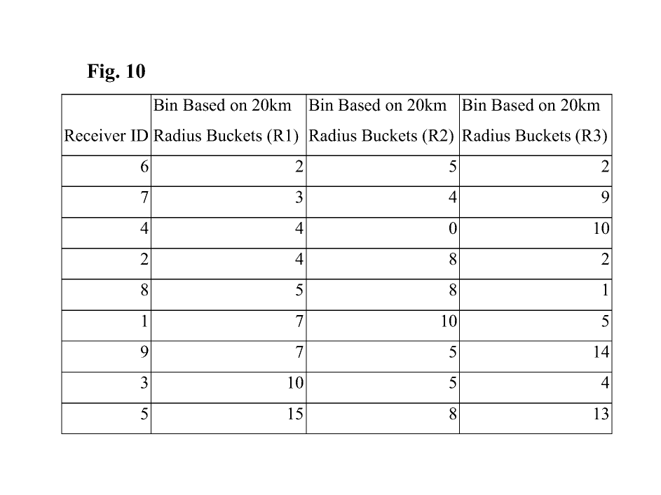

FIG. 11 exemplifies how data could be stored in individually sorted index entries, rather than in a single inversion entry as in FIG. 7. This is known as a columnar approach; and this example shows how the invention can be applied to other current and ongoing advances in database technology.

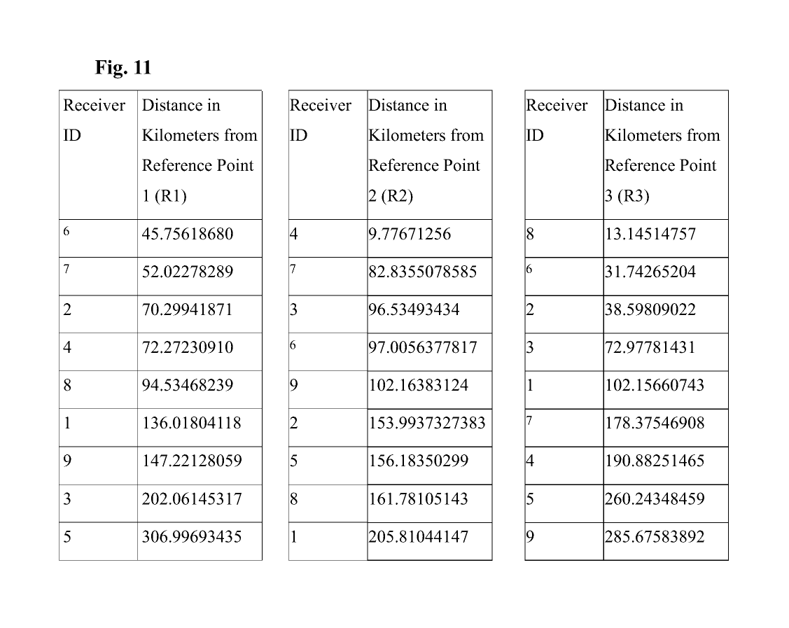

### DESCRIPTION OF EMBODIMENTS

The invention's embodiment is as a computer process for storing an index on database records and efficiently retrieving results from that index to respond to a database query with a distance related component. Example 1 illustrates the preferred embodiment, in which the database records represent points on a standard globe or 2-dimensional projection of such, where distances must account for the curvature of the earth.

One embodiment stores the index as distances from specific reference points, with a precision sufficient to accommodate the individual application. Other embodiments store bucketed distances, as described in paragraphs [0035] and [0036], or a combination of bucketed and discrete distances.

The use of the globe or 2-dimensional map is incidental, but likely to be a common use. The invention's embodiment can include the indexing of distances applicable to almost any comparison function, including examples in paragraphs [0012]-[0016].

### EXAMPLE

In over-the-air broadcasting situations such as radio, television, and cellular telephone, it is common to want to determine how many radio receivers are within a given distance of broadcasting towers. Assume a database holds the latitude and longitude of 100,000 radio receivers and 1000 broadcast towers, and the broadcast operator wants to know what percent of receivers are within 10 kilometers of the towers.

A typical SQL query may look like this:

```
SELECT COUNT(1)
FROM RECEIVERS R
  JOIN TOWERS T ON
  ST_DISTANCE(R.LOCATION, T.LOCATION, ‘kilometers’) <= 10;
```

A naïve solution would require the expensive ST_DISTANCE function be called 100,000,000 times (100,000 receivers times 1000 towers).

Existing geo-spatial indexes can improve on this. The most common index scheme in use by databases as of this writing is described in patent US20030187867, wherein the data are organized into rectangular hierarchical regions of decreasing size. To be most efficient, this method requires that the 10 kilometer distance important to the query is reasonably accommodated by the sizes of the regions at some level in the hierarchy. If the smallest regions are more than roughly 10 kilometers from corner to corner then the database cannot automatically assume that two points within the region are less than 10 kilometers from one another. The distance function must be calculated in all comparisons. Similarly, regions less than 5 kilometers from corner to corner require that points which are alone in a region must still consider regions two steps away to ensure the 10 kilometer requirement is met. It is common to have to tune the size of these regions to optimize their use for a given application.

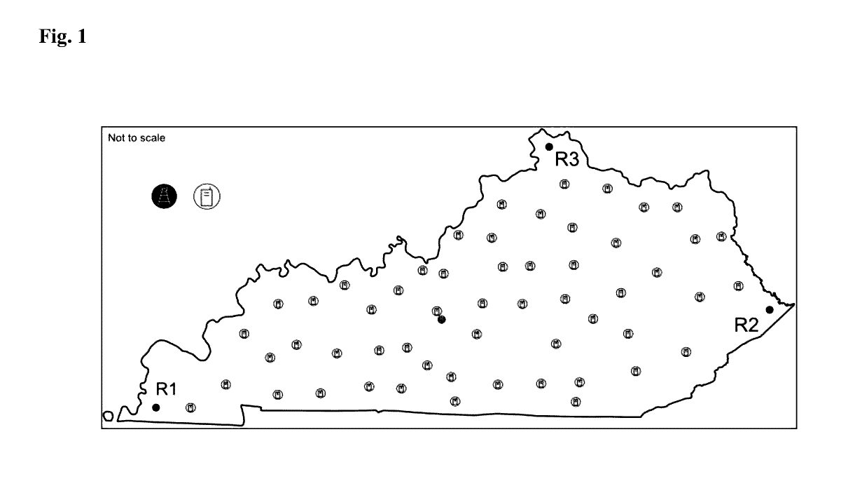

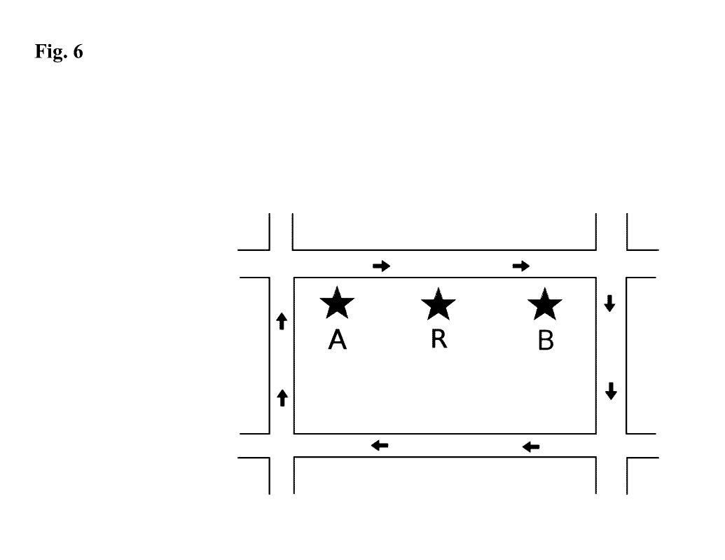

The current invention does not require such tuning (though claim 3 allows it, in cases where lower precision is preferred, possibly to lower storage requirements by limiting the number of bytes used to store the index). Since the example query concerns positions on a globe, typically four reference points should be created, and the distances from each reference point to each receiver and each tower stored in indexes. In FIG. 1, a simplified 2-dimensional map with three reference points, one broadcast tower, and a number of receivers is illustrated. FIG. 6 depicts how the data could be stored in a typical index where the index is sorted based on the distances store, so as to more efficiently retrieve records based on distance queries.

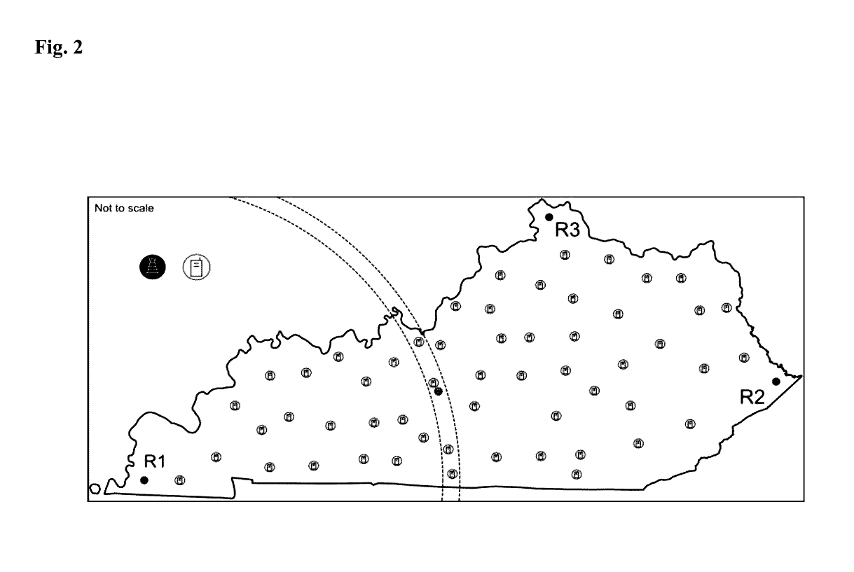

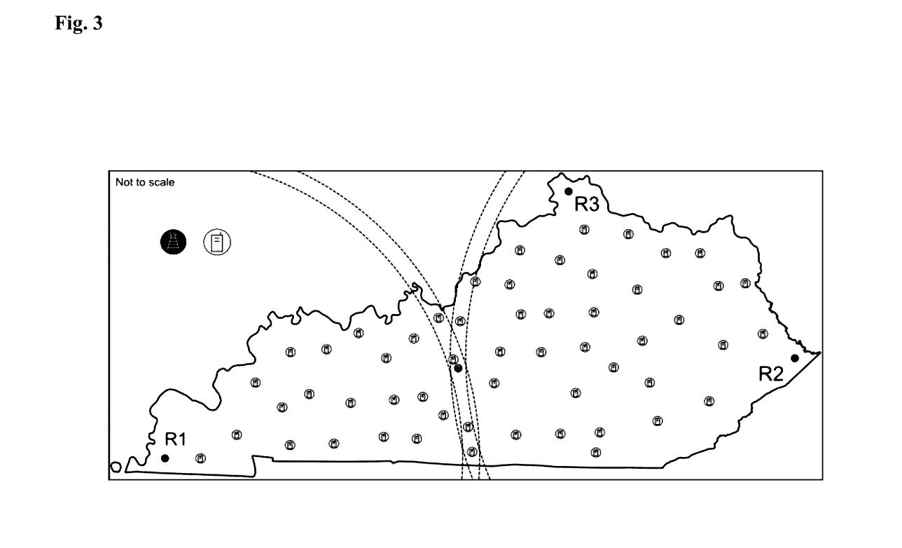

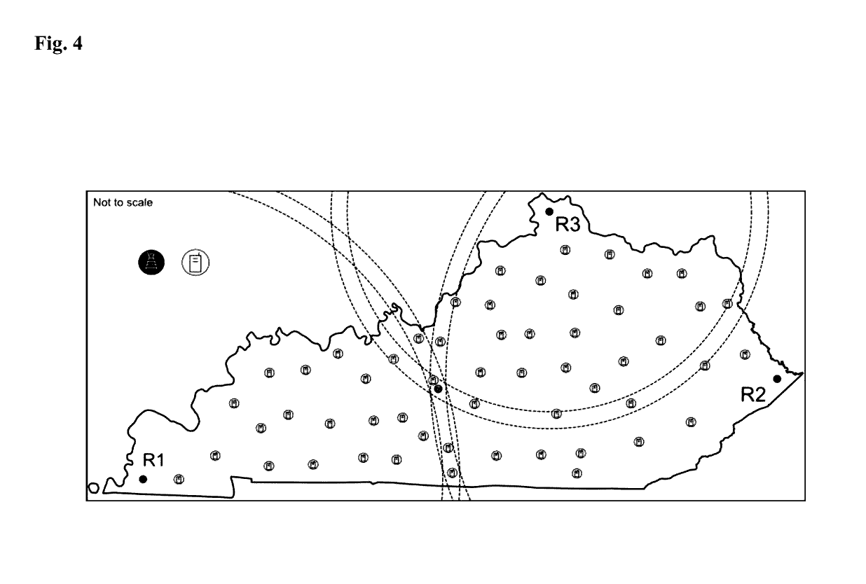

If a broadcast tower is, say, 50 kilometers from reference point 1, then only receivers which are 40 to 60 kilometers from that point need to be considered. This reduces the search space considerably (see FIG. 2). Next, if the tower is 100 kilometers from reference point 2, the remaining receivers must be between 90 and 110 kilometers from that point to satisfy the query condition (as shown in FIG. 3). This continues for reference points 3 and 4, or until all receivers have been eliminated as being more than 10 kilometers from the tower (see FIG. 4).

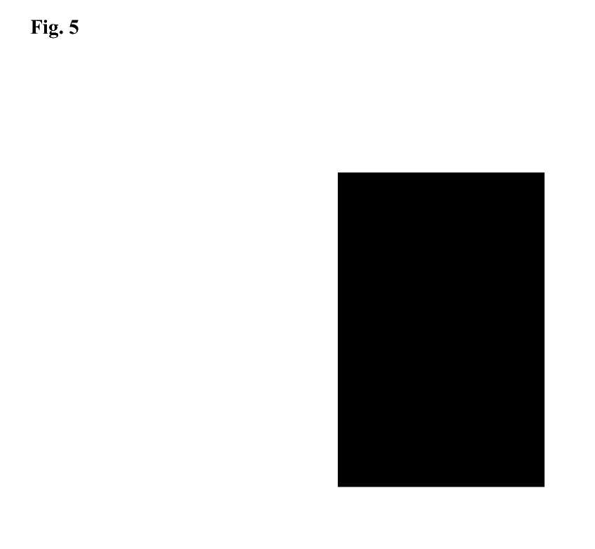

If not all receivers have been eliminated, then the distance function must still be calculated for those which remain, as there are circumstances where, even after the four comparisons, the receivers may be more than 10 kilometers from the tower (see FIG. 5).

FIG. 6 has an example of how the information for 9 towers may be stored in an index sorted with respect to reference point 1. Note that each row corresponds to the record index (i), and the vector of distances described in paragraph 0006 Vᵢ[1 . . . 3]. In this case, if a radio tower X were located 50 km from R1, 90 km from R2, and 180 km from R3, (making Vₓ[50,90,180]) then all but the first two records could be excluded immediately due to the sorted R1 distances since the third record's entry is more than 50 km+10 km, and the subsequent records must be further due to the sort order. The second reference point causes no elimination since P₆ and P₇ are both within 10 km of the 90 km tower distance from R₂. The third reference point eliminates P₆ since it is more than 10 km from the 180 km tower distance, however P7 remains since the indexed value is within 10 km of the 180 km tower distance. Once the index was created, only four distance functions needed to be performed to satisfy the query—the three to create Vₓ, and the final f(P7, X) to ensure the anomaly described in paragraph [0069] and FIG. 5 did not occur.

### INDUSTRIAL APPLICABILITY

The invention is applicable to the industry of computer science and data processing including data analytics and business intelligence.

### CITATION LIST

### Patent Literature

https://www.google.com/patents/US6263334
https://www.google.com/patents/US20030187867
https://www.google.com/patents/US7689621
https://www.google.com/patents/US7185023
https://www.google.com/patents/US7917458
https://www.google.co.in/patents/US6285999

### Non Patent Literature

http://technet.microsoft.com/en-us/library/bb964712(v=sql.105).aspx
https://en.wikipedia.org/wiki/Spatial database
http://blogs.msdn.com/b/isaac/archive/2008/10/23/nearest-neighbors.aspx

1. A computer implemented method for storing data in an index comprising:
identifying a metric distance function applying to the database records
establishing a set of reference points
calculating the distances between each of said data records and each of said reference points
storing the results in a computer attached storage medium in a sorted order, that sorted order being specified by the specific distance from a specified reference point

2. The method in claim 1 further comprising:
establishing a binning distance
associating each record with bins based on how many multiples of the binning distance the recorded data point is from each reference point
storing said bins for each record in a computer attached storage medium in a sorted order based on the binned distances

3. The method of claims 1 and 2 wherein:
a combination of bins as in claim 2 and discrete distances as in claim 1 are stored together

4. The method of claims 1-3 wherein:
the distance function is not invertible or does not satisfy the basic triangle inequality
an error value is included with the index indicating the maximum discrepancy in the inversion of the distance function

5. A method of searching a set of database records with an index formed from a method claimed herein, comprising:
receiving a database request with a distance related query
calculating relative distance boundaries from the reference points satisfying said query
searching the relative distances stored in the index based on the relative distance boundaries relying on the sort order of the index entries resulting in a set of candidate records
performing the distance function calculation on said candidate records according to the needs of the query resulting in a final set of records
returning said final set of records as a response to the database request

6. The method of claim 5 wherein:
the calculation and searching of the relative distance boundaries is adjusted to account for the error value in claim 4
